(19) United States
(12) Patent Application Publication
(10) Pub. No.: US 2026/0143496 A1
(43) Pub. Date: May 21, 2026

(54) EFFICIENT RATE-MATCHING AROUND CONTROL RESOURCES

(71) Applicant: QUALCOMM Incorporated, San Diego, CA (US)

(72) Inventors: Gabi SARKIS, San Diego, CA (US); Jing SUN, San Diego, CA (US); Weimin DUAN, San Diego, CA (US); Mostafa KHOSHNEVISAN, San Diego, CA (US); Jing JIANG, San Diego, CA (US); Diana MAAMARI, San Diego, CA (US)

(21) Appl. No.: 18/949,895

(22) Filed: Nov. 15, 2024

(51) Int. Cl. H04W 72/23; H04W 72/1263

(52) U.S. Cl. CPC H04W 72/23; H04W 72/1263

(57) ABSTRACT

Methods, systems, and devices for wireless communications are described. A user equipment (UE) may rate match around one or more patterns of a control resource set (CORESET) based on a segmentation scheme. For example, the UE may receive downlink control information (DCI) via a first CORESET. The DCI may indicate a segmentation scheme that subdivides one or more CORESETs, including the first CORESET, into respective sets of patterns. Then, the UE may perform a rate matching procedure based on the segmentation scheme and a set of resources corresponding to the DCI. The UE may perform the rate matching procedure around a subset of a respective set of patterns of at least one of the one or more CORESETs overlapping the set of resources. The UE may determine the resources for the downlink data channel message based on the rate matching procedure.

### FIELD OF TECHNOLOGY

The following relates to wireless communications, including rate matching around control resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, via a first control resource set (CORESET), downlink control information (DCI) that indicates a segmentation scheme including a codepoint that subdivides one or more CORESETs into respective pluralities of patterns, the one or more CORESETs including the first CORESET and performing, based on the segmentation scheme and a set of resources corresponding to the DCI, a rate matching procedure around a subset of the respective set of multiple patterns of at least one of the one or more CORESETs that overlaps with the set of resources.

A UE for wireless communications is described. The UE may include one or more memories storing processor executable code, and one or more processors coupled with the one or more memories. The one or more processors may individually or collectively be operable to execute the code to cause the UE to receive, via a first CORESET, DCI that indicates a segmentation scheme including a codepoint that subdivides one or more CORESETs into respective pluralities of patterns, the one or more CORESETs including the first CORESET and perform, based on the segmentation scheme and a set of resources corresponding to the DCI, a rate matching procedure around a subset of the respective set of multiple patterns of at least one of the one or more CORESETs that overlaps with the set of resources.

Another UE for wireless communications is described. The UE may include means for receiving, via a first CORESET, DCI that indicates a segmentation scheme including a codepoint that subdivides one or more CORESETs into respective pluralities of patterns, the one or more CORESETs including the first CORESET and means for performing, based on the segmentation scheme and a set of resources corresponding to the DCI, a rate matching procedure around a subset of the respective set of multiple patterns of at least one of the one or more CORESETs that overlaps with the set of resources.

A non-transitory computer-readable medium storing code for wireless communications is described. The code may include instructions executable by one or more processors to receive, via a first CORESET, DCI that indicates a segmentation scheme including a codepoint that subdivides one or more CORESETs into respective pluralities of patterns, the one or more CORESETs including the first CORESET and perform, based on the segmentation scheme and a set of resources corresponding to the DCI, a rate matching procedure around a subset of the respective set of multiple patterns of at least one of the one or more CORESETs that overlaps with the set of resources.

In some examples of the method, UEs, and non-transitory computer-readable medium described herein, the DCI allocates resources for a downlink data channel message and the method, apparatuses, and non-transitory computer-readable medium may include further operations, features, means, or instructions for receiving the downlink data channel message, where the resources for the downlink data channel message may be determined based on the rate matching procedure.

Some examples of the method, UEs, and non-transitory computer-readable medium described herein may further include operations, features, means, or instructions for receiving control signaling that indicates a second CORESET of the one or more CORESETs, where the rate matching procedure may be performed around the subset of the respective set of multiple patterns of the second CORESET that overlap with the set of resources.

In some examples of the method, UEs, and non-transitory computer-readable medium described herein, performing the rate matching procedure may include operations, features, means, or instructions for performing the rate matching procedure around the first CORESET based on the control signaling indicating the second CORESET.

In some examples of the method, UEs, and non-transitory computer-readable medium described herein, performing the rate matching procedure may include operations, features, means, or instructions for performing, based on the control signaling indicating the second CORESET, the rate matching procedure around a first subset of a first set of multiple patterns corresponding to the first CORESET that overlap with the set of resources.

In some examples of the method, UEs, and non-transitory computer-readable medium described herein, the segmentation scheme subdivides the second CORESET into a respective set of multiple patterns.

Some examples of the method, UEs, and non-transitory computer-readable medium described herein may further include operations, features, means, or instructions for receiving, via radio resource control (RRC) signaling or via a medium access control-control element (MAC-CE), a configuration for respective segmentation schemes associated with one or more codepoints including the codepoint, the rate matching procedure, or both.

Some examples of the method, UEs, and non-transitory computer-readable medium described herein may further include operations, features, means, or instructions for receiving, via RRC signaling or via a MAC-CE, a respective configuration for each search space of a set of search spaces, for each search space set group of a set of search space set groups, for each CORESET of a set of control resources sets, for each bandwidth part of a set of bandwidth parts, for each cell of a set of cells, or any combination thereof, where each respective configuration may be for one or more codepoints associated with a respective segmentation scheme, the rate matching procedure, or both.

In some examples of the method, UEs, and non-transitory computer-readable medium described herein, the respective pluralities of patterns may be contiguous within each CORESET of the one or more CORESETs.

In some examples of the method, UEs, and non-transitory computer-readable medium described herein, the respective pluralities of patterns may be non-contiguous within each CORESET of the one or more CORESETs.

In some examples of the method, UEs, and non-transitory computer-readable medium described herein, a configuration for the segmentation scheme subdivides the one or more CORESETs into the respective pluralities of patterns according to a bitmap or according to an indication of a set of ranges within the first CORESET.

In some examples of the method, UEs, and non-transitory computer-readable medium described herein, an indication of the subset of the respective pluralities of patterns may be based on an explicit field of the DCI or a mask of a cyclic redundancy check field.

In some examples of the method, UEs, and non-transitory computer-readable medium described herein, the respective pluralities of patterns may be configured based on a physical downlink shared channel (PDSCH) mapping type corresponding to the DCI.

A method for wireless communications by a network entity is described. The method may include outputting, via a first CORESET, DCI including a codepoint that indicates a segmentation scheme that subdivides one or more CORESETs into respective pluralities of patterns, the one or more CORESETs including the first CORESET and outputting a downlink data channel message, where, based on the segmentation scheme, resources for the downlink data channel message are rate matched around a subset of the respective set of multiple patterns of at least one of the one or more CORESETs that overlap with a set of resources corresponding to the DCI.

A network entity for wireless communications is described. The network entity may include one or more memories storing processor executable code, and one or more processors coupled with the one or more memories. The one or more processors may individually or collectively be operable to execute the code to cause the network entity to output, via a first CORESET, DCI including a codepoint that indicates a segmentation scheme that subdivides one or more CORESETs into respective pluralities of patterns, the one or more CORESETs including the first CORESET and output a downlink data channel message, where, based on the segmentation scheme, resources for the downlink data channel message are rate matched around a subset of the respective set of multiple patterns of at least one of the one or more CORESETs that overlap with a set of resources corresponding to the DCI.

Another network entity for wireless communications is described. The network entity may include means for outputting, via a first CORESET, DCI including a codepoint that indicates a segmentation scheme that subdivides one or more CORESETs into respective pluralities of patterns, the one or more CORESETs including the first CORESET and means for outputting a downlink data channel message, where, based on the segmentation scheme, resources for the downlink data channel message are rate matched around a subset of the respective set of multiple patterns of at least one of the one or more CORESETs that overlap with a set of resources corresponding to the DCI.

A non-transitory computer-readable medium storing code for wireless communications is described. The code may include instructions executable by one or more processors to output, via a first CORESET, DCI including a codepoint that indicates a segmentation scheme that subdivides one or more CORESETs into respective pluralities of patterns, the one or more CORESETs including the first CORESET and output a downlink data channel message, where, based on the segmentation scheme, resources for the downlink data channel message are rate matched around a subset of the respective set of multiple patterns of at least one of the one or more CORESETs that overlap with a set of resources corresponding to the DCI.

In some examples of the method, network entities, and non-transitory computer-readable medium described herein, the resources for the downlink data channel message may be determined based on a rate matching procedure for the resources.

Some examples of the method, network entities, and non-transitory computer-readable medium described herein may further include operations, features, means, or instructions for outputting control signaling that indicates a second CORESET of the one or more CORESETs, where the resources for the downlink data channel message may be rate matched around the subset of the respective set of multiple patterns of the second CORESET that overlap with the set of resources.

In some examples of the method, network entities, and non-transitory computer-readable medium described herein, the resources for the downlink data channel message may be rate matched around the first CORESET based on the control signaling indicating the second CORESET.

In some examples of the method, network entities, and non-transitory computer-readable medium described herein, based on the control signaling indicating the second CORESET, the resources for the downlink data channel message may be rate matched around a first subset of a first set of multiple patterns corresponding to the first CORESET that overlap with the set of resources.

In some examples of the method, network entities, and non-transitory computer-readable medium described herein, the segmentation scheme subdivides the second CORESET into a respective set of multiple patterns.

Some examples of the method, network entities, and non-transitory computer-readable medium described herein may further include operations, features, means, or instructions for outputting, via RRC signaling or via a MAC-CE, a configuration for respective segmentation schemes associated with one or more codepoints including the codepoint, a rate matching procedure for the resources, or both.

Some examples of the method, network entities, and non-transitory computer-readable medium described herein may further include operations, features, means, or instructions for outputting, via RRC signaling or via a MAC-CE, a respective configuration for each search space of a set of search spaces, for each search space set group of a set of search space set groups, for each CORESET of a set of control resources sets, for each bandwidth part of a set of bandwidth parts, for each cell of a set of cells, or any combination thereof, where each respective configuration may be for one or more codepoints associated with a respective segmentation scheme, a rate matching procedure for the resources, or both.

In some examples of the method, network entities, and non-transitory computer-readable medium described herein, the respective pluralities of patterns may be contiguous within each CORESET of the one or more CORESETs.

In some examples of the method, network entities, and non-transitory computer-readable medium described herein, the respective pluralities of patterns may be non-contiguous within each CORESET of the one or more CORESETs.

In some examples of the method, network entities, and non-transitory computer-readable medium described herein, a configuration for the segmentation scheme subdivides the one or more CORESETs into the respective pluralities of patterns according to a bitmap or according to an indication of a set of ranges within the first CORESET.

In some examples of the method, network entities, and non-transitory computer-readable medium described herein, an indication of the subset of the respective pluralities of patterns may be based on an explicit field of the DCI or a mask of a cyclic redundancy check field.

In some examples of the method, network entities, and non-transitory computer-readable medium described herein, the respective pluralities of patterns may be configured based on a PDSCH mapping type corresponding to the DCI.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports rate matching around control resources in accordance with one or more aspects of the present disclosure.

FIG. 2 shows an example of a wireless communications system that supports rate matching around control resources in accordance with one or more aspects of the present disclosure.

FIGS. 3A-3D each show a respective example of a control resource set (CORESET) rate matching diagram that supports rate matching around control resources in accordance with one or more aspects of the present disclosure.

FIG. 4 shows an example of a process flow that supports rate matching around control resources in accordance with one or more aspects of the present disclosure.

FIGS. 5 and 6 show block diagrams of devices that support rate matching around control resources in accordance with one or more aspects of the present disclosure.

FIG. 7 shows a block diagram of a communications manager that supports rate matching around control resources in accordance with one or more aspects of the present disclosure.

FIG. 8 shows a diagram of a system including a device that supports rate matching around control resources in accordance with one or more aspects of the present disclosure.

FIGS. 9 and 10 show block diagrams of devices that support rate matching around control resources in accordance with one or more aspects of the present disclosure.

FIG. 11 shows a block diagram of a communications manager that supports rate matching around control resources in accordance with one or more aspects of the present disclosure.

FIG. 12 shows a diagram of a system including a device that supports rate matching around control resources in accordance with one or more aspects of the present disclosure.

FIGS. 13 through 15 show flowcharts illustrating methods that support rate matching around control resources in accordance with one or more aspects of the present disclosure.

### DETAILED DESCRIPTION

In some wireless communications systems, a user equipment (UE) may receive control signaling such as a control format indicator (CFI). The CFI may indicate a quantity of symbols that are in a subframe within downlink signaling. The UE may decode the CFI prior to decoding downlink control information, which may increase latency and complexity (e.g., decoding two messages rather than one). In some cases, the UE may rate match a physical downlink shared channel (PDSCH) around a physical downlink control channel (PDCCH) (e.g., a scheduling PDCCH) within a control resource set (CORESET). The UE may receive an indication to rate match around one or more semi-static patterns (e.g., semi-static sub-CORESETs). Increasing dynamic rate matching granularity may increase a quantity of bits used for such an indication (e.g., rate matching mechanisms), thus increasing signaling overhead. Accordingly, techniques described herein may support a robust and flexible data rate matching procedure around a set of control resources.

A UE may rate match around one or more patterns (e.g., sub-CORESETs) of a CORESET based on a segmentation scheme. For example, the UE may receive DCI via a first CORESET. The DCI may indicate a segmentation scheme that subdivides one or more CORESETs, including the first CORESET, into respective sets of patterns. Then, the UE may perform a rate matching procedure based on the segmentation scheme and a set of resources corresponding to the DCI. The UE may perform the rate matching procedure around a subset of a respective set of patterns (e.g., of the respective sets of patterns) of at least one of the one or more CORESETs that overlaps with the set of resources. In some cases, the UE may receive the downlink data channel message, and may determine the resources for the downlink data channel message based on the rate matching procedure (e.g., rate matching around the set of resources corresponding to the DCI). In some examples, the UE may receive control signaling that indicates a second CORESET of the one or more CORESETs. In such examples, the UE may perform the rate matching procedure around the subset of a second respective set of patterns corresponding to the second CORESET that overlap with the set of resources (of the DCI).

Aspects of the disclosure are initially described in the context of wireless communications systems. Aspects of the disclosure are then described with reference to CORESET rate matching diagrams and a process flow. Aspects of the disclosure are further illustrated by and described with reference to apparatus diagrams, system diagrams, and flowcharts that relate to rate matching around control resources.

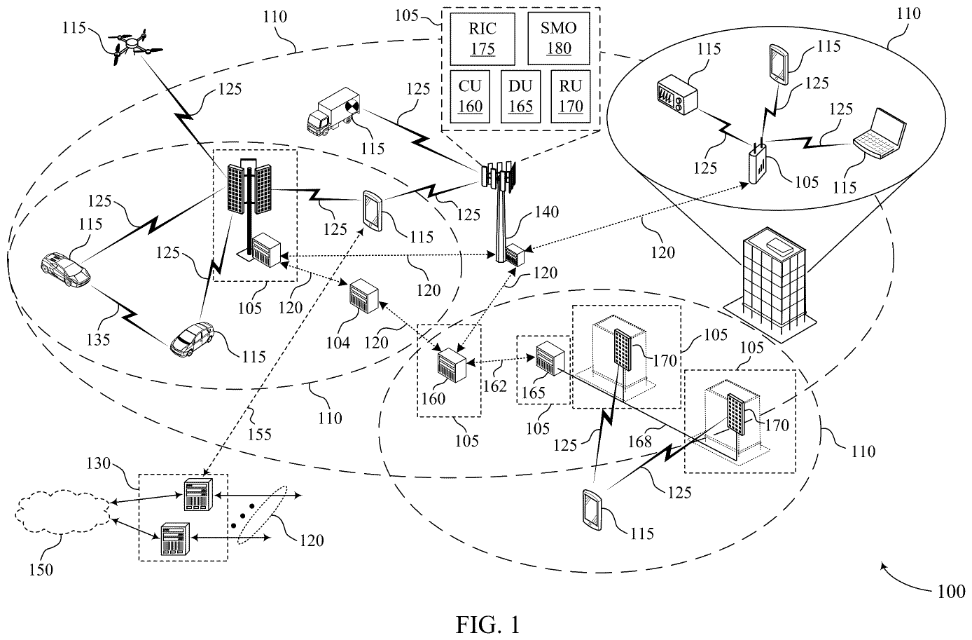

FIG. 1 shows an example of a wireless communications system 100 that supports rate matching around control resources in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support rate matching around control resources as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a CFI may indicate a quantity of (e.g., how many) symbols that may be used to carry control information in a subframe. In some cases, a separate channel (e.g., a physical CFI channel (PCFICH)) may carry the CFI. The CFI may indicate one or more values. For example, if the CFI has a value of ‘1’, then one symbol may be used for control in a corresponding subframe. If the CFI has a value of ‘2’, then two symbols may be used for control in the corresponding subframe. If the CFI has a value of ‘3’, then three symbols may be used for control in the corresponding subframe. A value of ‘4’ at the CFI may be reserved (e.g., for indicating one or more other aspects related to the subframe). In some wireless communications systems, a UE may decode a CFI before the UE can decode a corresponding DCI. This may increase latency and reduce robustness (e.g., since the UE would have to decode two messages instead of one).

In some wireless communications systems, a device (e.g., a UE or a network entity) may rate match a physical downlink shared channel (PDSCH) transmission around a physical downlink control channel (PDCCH) transmission (e.g., a DCI message) using one or more methods. For example, the device may rate match around a CORESET corresponding to the PDCCH transmission. In some examples, the device may rate match the PDSCH transmission around a scheduling PDCCH. The device may implement frequency domain resource allocation (FDRA), time domain resource allocation (TDRA), or both, to perform the rate matching. The device may receive an indication to rate match around one or more semi-static patterns. For example, the device may support a mechanism to rate match around control signals, other signals, or the like (e.g., for forward compatibility). The device may also support a shortened transmission time interval (sTTI), which may provide a similar rate matching mechanism using groups of shortened control channel elements (sCCEs). In some cases, increasing dynamic rate matching granularity may increase a quantity of bits that are used for these mechanisms.

Some wireless communications systems may support a configuration for two rate matching patterns (e.g., via an RRC configuration). In some cases, up to two DCI bits may indicate whether a device is to rate match around one or more of the two rate matching patterns. For example, a first bit may indicate that the device is to rate match around a first pattern (e.g., pattern 1) and a second bit may indicate that the device is to rate match around a second pattern (e.g., pattern 2). Each pattern may be a bitmap or a CORESET and may have a periodicity.

As described herein, the wireless communications system 100 may support (e.g., enable) a robust and flexible data rate matching procedure around a set of control resources. For example, the wireless communications system 100 may support a UE 115 to rate match around one or more patterns (sometimes referred to as sub-CORESETs) of a CORESET based on a segmentation scheme. In some cases, the UE 115 may receive DCI via a first CORESET. The DCI may indicate a segmentation scheme that subdivides one or more CORESETs, including the first CORESET, into respective sets of patterns. Then, the UE 115 may perform a rate matching procedure based on the segmentation scheme and a set of resources corresponding to the DCI. The UE 115 may perform the rate matching procedure around a subset of a respective set of patterns (e.g., of the respective sets of patterns) of at least one of the one or more CORESETs that overlaps with the set of resources. In some cases, the UE 115 may receive the downlink data channel message, and may determine the resources for the downlink data channel message based on the rate matching procedure (e.g., rate matching around the set of resources corresponding to the DCI). In some examples, the UE 115 may receive control signaling that indicates a second CORESET of the one or more CORESETs. In such examples, the UE 115 may perform the rate matching procedure around the subset of a second respective set of patterns corresponding to the second CORESET that overlap with the set of resources (of the DCI).

As described herein, rate matching “around” a first set of resources may refer to rate matching a second set of resources for a message (e.g., a data message) around the first set of resources. For example, a UE 115 may perform a rate matching procedure, as part of receiving the message, to rate match the second set of resources for the message based on the first set of resources (e.g., avoiding rate matching the resources for the one message to the first set of resources). The UE 115 may allocate the second set of resources for the message based on a segmentation scheme. For example, the UE 115 may select the second set of resources according to a set of patterns that are based on the segmentation scheme and the first set of resources. As described herein, a PDCCH transmission may refer to or may include a DCI message. Further, a PDSCH transmission may refer to or may include a data channel message.

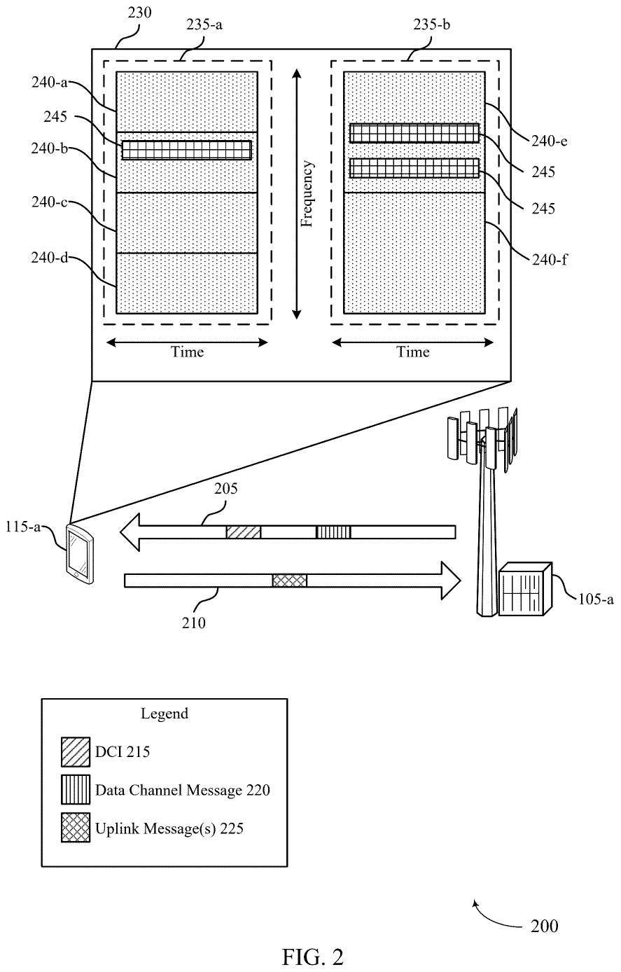

FIG. 2 shows an example of a wireless communications system 200 that supports rate matching around control resources in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein. The UE 115-a may receive signaling from the network entity 105-a via the wireless communication link 205 and may transmit signaling to the network entity 105-a via the wireless communication link 210.

In some implementations, the UE 115-a may receive DCI 215 from the network entity 105-a via the wireless communication link 205. The DCI 215 may include a codepoint that indicates a segmentation scheme that subdivides a CORESET (or multiple CORESETs) into a set of patterns. Then, the UE 115-a may receive a data channel message 220 (e.g., a downlink data channel message). To receive the data channel message 220, the UE 115-a may perform a rate matching procedure 230 to rate match resources for the data channel message 220 around resources for the DCI 215. The UE 115-a may perform the rate matching procedure 230 based on the one or more segmentation schemes. In some cases, the UE 115-a may transmit one or more uplink messages 225 to the network entity 105-a via the wireless communication link 210 (e.g., in response to the data channel message 220). In some implementations, the network entity 105-a may perform a rate matching procedure 230 similar to the rate matching procedure 230 performed by the UE 115-a (e.g., to transmit the data channel message 220).

The UE 115-a may communicate (e.g., transmit or receive messages) using resources from a CORESET 235. In some cases, the DCI 215 may indicate one or more segmentation schemes. The UE 115-a may use the one or more segmentation schemes to subdivide the CORESET 235 into a set of patterns 240. For example, the UE 115-a may use a first segmentation scheme to subdivide a CORESET 235-a into a first set of patterns 240 (e.g., four patterns, including a pattern 240-a, a pattern 240-b, a pattern 240-c, and a pattern 240-d). Similarly, the UE 115-a may use a second segmentation scheme to subdivide a CORESET 235-b into a second set of patterns 240 (e.g., two patterns, including a pattern 240-e and a pattern 240-f). As shown in FIG. 2, each CORESET 235 (e.g., the CORESET 235-a and the CORESET 235-b) may be illustrated such that a vertical axis may represent a frequency axis and such that a horizontal axis may represent a time axis. Accordingly, a segmentation scheme may subdivide a CORESET 235 into patterns 240 with respect to frequency, with respect to time, or both. FIG. 2 illustrates that each CORESET 235 may be subdivided into patterns 240 with respect to frequency (e.g., each pattern 240 spans a unique range of frequencies).

In some implementations, the UE 115-a may perform the rate matching procedure 230 to rate match a set of resources for the data channel message 220 around resources 245, which correspond to the DCI 215 (e.g., the UE 115-a may receive the DCI 215 via the resources 245). In a first alternative, the UE 115-a may subdivide the CORESET 235-a into four patterns 240 according to the first segmentation scheme. In some cases, the first segmentation scheme may be based on a location of the resources 245 within the CORESET 235-a. Then, the UE 115-a may determine a pattern 240 that overlaps (e.g., includes) the resources 245 corresponding to the DCI 215. For example, the UE 115-a may determine that the pattern 240-b overlaps with the resources 245. Accordingly, the UE 115-a may rate match resources from the remaining patterns 240 (e.g., the pattern 240-a, the pattern 240-c, and the pattern 240-d) for the data channel message 220.

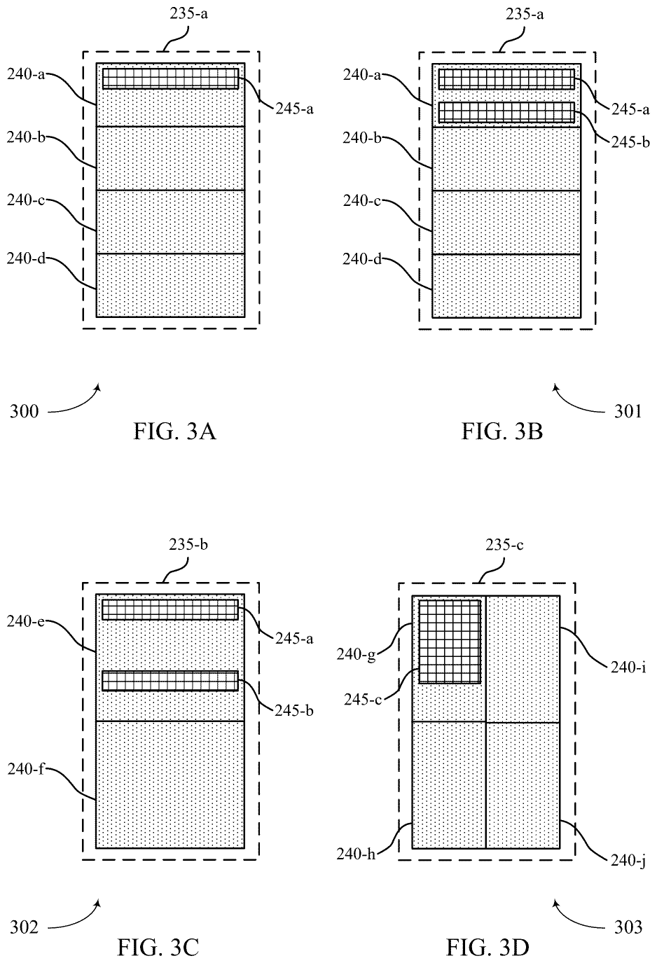

In a second alternative, the UE 115-a may subdivide the CORESET 235-b into two patterns 240 according to the second segmentation scheme. In some cases, the second segmentation scheme may be based on a location of the resources 245 within the CORESET 235-a. Then, the UE 115-a may determine a pattern 240 that overlaps (e.g., includes) the resources 245 corresponding to the DCI 215. In some examples, the resources 245 may include resources for a second DCI 215 for a second UE 115. The UE 115-a may determine that the pattern 240-e overlaps with the resources 245. Accordingly, the UE 115-a may rate match resources from the remaining patterns 240 (e.g., the pattern 240-f) for the data channel message 220. Further examples and implementations are illustrated and described with reference to FIGS. 3A-3D.

In some implementations, the UE 115-a may segment a CORESET 235 into sub-CORESETs and may use the sub-CORESETs as rate matching units for the rate matching procedure 230. As described herein, the terms “sub-CORESET” and “pattern” (e.g., a pattern 240) may be used interchangeably to refer to a portion of a CORESET 235. In some cases, the UE 115-a may apply this segmentation for the purpose of rate matching. In some examples, sub-CORESETs may be uniform or non-uniform with respect to size. For example, a first sub-CORESET may span a first range of frequencies or a first duration, while a second sub-CORESET may span a second range of frequencies different from the first range of frequencies or a second duration different from the first duration. In some cases, sub-CORESETs may overlap (e.g., with respect to frequency or time).

In some implementations, a scheduler (e.g., a scheduling component or device) may group (e.g., pack) resources 245 corresponding to PDCCH transmissions into relatively few sub-CORESETs (e.g., as few sub-CORESETs as possible). For example, the DCI 215 may indicate a segmentation scheme that is based on locations of the resources 245 within a CORESET 235 such that a quantity of sub-CORESETs is less than a threshold quantity. The DCI 215 (e.g., a scheduling DCI) may indicate which sub-CORESETs are occupied within the CORESET 235.

In some cases, a DCI 215 may indicate (e.g., signal) one or more segmentation schemes (e.g., a set of different segmentation schemes). The DCI 215 may include a 2-bit indication that indicates a segmentation scheme from the one or more segmentation schemes. For example, the 2-bit indication may have a value of ‘0’ (e.g., ‘00’), which may indicate that the UE 115-a is to rate match around a detected PDCCH transmission (e.g., resources 245 corresponding to the detected PDCCH transmission). A value of ‘1’ (e.g., ‘01’) may indicate that the UE 115-a is to rate match around 1/4 of the CORESET 235 (e.g., segmenting the CORESET 235 into four sub-CORESETs) that includes a detected PDCCH transmission (e.g., a DCI 215). A value of ‘2’ (e.g., ‘10’) may indicate that the UE 115-a is to rate match around ½ of the CORESET 235 (e.g., segmenting the CORESET 235 into two sub-CORESETs) that includes a detected PDCCH transmission. A value of ‘3’ (e.g., ‘11’) may indicate that the UE 115-a is to rate match around the CORESET 235 (e.g., the entire CORESET). Accordingly, the UE 115-a may use resources from one or more other CORESETs 235 to receive the data channel message 220.

In some implementations, the DCI 215 may indicate that the UE 115-a is to rate match around one or more other CORESETs 235. For example, the DCI 215 may indicate one or more CORESET indexes (e.g., corresponding to the one or more other CORESETs 235). Additionally, or alternatively, the DCI may indicate the one or more other CORESETs (e.g., to rate match around) by extending aspects related to sub-CORESETs (e.g., as described herein) to include indicating resources from multiple CORESETs. In some examples, the UE 115-a may receive signaling that indicates the one or more other CORESETs to rate match around jointly with or separately from the DCI 215 (e.g., based on a second DCI 215).

In some cases, the UE 115-a may rate match around a CORESET 235 that includes (e.g., overlaps with) a detected PDCCH transmission. For example, the UE 115-a may rate match around an entire CORESET 235 (e.g., a first CORESET 235) that includes the detected PDCCH transmission in response to an indication to rate match around resources in the one or more other CORESETs 235. Additionally, or alternatively, the UE 115-a may rate match around an indicated set of resources within the CORESET 235.

In some implementations, the network entity 105-a (or another device) may configure one or more codepoints of the DCI 215. For example, the DCI 215 may include an alternative 2-bit indication for the rate matching procedure 230. The alternative 2-bit indication may have a value of ‘0’ (e.g., ‘00’), which may indicate that the UE 115-a is to rate match around ¼ of a CORESET 235 (e.g., segmenting the CORESET 235 into four sub-CORESETs) that includes a detected PDCCH transmission. A value of ‘1’ (e.g., ‘01’) may indicate that the UE 115-a is to rate match around ½ of the CORESET 235 (e.g., segmenting the CORESET 235 into two sub-CORESETs) that includes a detected PDCCH transmission. A value of ‘2’ (e.g., ‘10’) may indicate that the UE 115-a is to rate match around ¾ of the CORESET 235 (e.g., segmenting the CORESET 235 into two sub-CORESETs, where a first sub-CORESET spans ¾ of the CORESET 235 and a second sub-CORESET spans ¼ of the CORESET 235) that includes a detected PDCCH transmission. A value of ‘3’ (e.g., ‘11’) may indicate that the UE 115-a is to rate match around the CORESET 235 (e.g., the entire CORESET). Accordingly, the UE 115-a may use resources from one or more other CORESETs 235 to receive the data channel message 220.

In some cases, a configuration (or multiple configurations) within the DCI 215 (e.g., for the rate matching procedure 230) may be for each search space of a set of search spaces, for each search space set group of a set of search space set groups, for each CORESET of a set of CORESETs, for each bandwidth part of a set of bandwidth parts, for each cell of a set of cells, or any combination thereof. In some examples, if a configuration is for each search space of a set of search spaces or for each search space set group of a set of search space set groups, a device (e.g., the UE 115-a or the network entity 105-a) may switch the configuration using a search space set group switching mechanism. In some implementations, the UE 115-a may receive medium access control-control element (MAC-CE) signaling or RRC signaling that configures (e.g., sets up) one or more codepoints of the configuration. Additionally, or alternatively, the MAC-CE signaling (or the RRC signaling) may change a set that the one or more codepoints point to. For example, the MAC-CE signaling may modify a meaning of one or more values of the 2-bit indication as described herein (e.g., such that a value of ‘1’ indicates that the UE 115-a is to rate-match around the entire CORESET 235, for example).

In some implementations, the sub-CORESETs (e.g., patterns 240) within the CORESET 235 may be contiguous or non-contiguous (e.g., a sum of the sub-CORESETs may span the entire CORESET 235 or a portion of the CORESET 235). The DCI 215 may indicate a configuration for the sub-CORESETs as a bitmap, or as a start-end indication (e.g., indicating a starting frequency and an ending frequency for a particular sub-CORESET). In some cases, an indication for the rate matching procedure 230 within the DCI 215 may be an explicit field of the DCI 215. Additionally, or alternatively, an indication for the rate matching procedure 230 within the DCI 215 may be masked on a set of cyclic redundancy check (CRC) bits. In some examples, an interpretation of a rate matching field within the DCI 215 may be based on (e.g., depend on) a PDSCH mapping type (e.g., corresponding to a PDSCH transmission).

FIG. 3A shows an example of a CORESET rate matching diagram 300 that supports rate matching around control resources in accordance with one or more aspects of the present disclosure. Aspects of the CORESET rate matching diagram 300 may implement or be implemented by one or more aspects as described herein with reference to FIGS. 1 and 2. For example, a UE 115 may perform a rate matching procedure to rate match a set of resources of a CORESET 235-a for a data channel message. The UE 115 may perform the rate matching procedure around resources 245-a corresponding to a DCI message (e.g., the UE 115 may receive the DCI via the resources 245-a). The DCI message may be for the UE 115.

The UE 115 may subdivide the CORESET 235-a into four patterns 240 according to a first segmentation scheme (e.g., as indicated by the DCI message). In some cases, the first segmentation scheme may be based on a location of the resources 245-a within the CORESET 235-a. Then, the UE 115 may determine one or more patterns 240 that overlap (e.g., include) the resources 245-a corresponding to the DCI message. For example, the UE 115 may determine that the pattern 240-a overlaps with the resources 245-a. In response, the UE 115 may rate match around pattern 240-a, while using resources from the remaining patterns 240 (e.g., the pattern 240-b, the pattern 240-c, and the pattern 240-d) for the data channel message 220. Where the DCI message indicates to rate match around the detected PDCCH transmission corresponding to the DCI, the UE 115 may rate match around the resources 245-a while using resources from the pattern 240-a that do not overlap with the resources 245-a

FIG. 3B shows an example of a CORESET rate matching diagram 301 that supports rate matching around control resources in accordance with one or more aspects of the present disclosure. Aspects of the CORESET rate matching diagram 301 may implement or be implemented by one or more aspects as described herein with reference to FIGS. 1 and 2. For example, a UE 115 may perform a rate matching procedure to rate match a set of resources of a CORESET 235-a for a data channel message. The UE 115 may perform the rate matching procedure around resources 245-a corresponding to a first DCI message (e.g., the UE 115 may receive the DCI via the resources 245-a) and around resources 245-b corresponding to a second DCI message. The first DCI message may be for the UE 115 and the second DCI message may be for a second UE 115.

The UE 115 may subdivide the CORESET 235-a into four patterns 240 according to a first segmentation scheme (e.g., as indicated by the DCI message). In some cases, the first segmentation scheme may be based on a location of the resources 245-a within the CORESET 235-a. Then, the UE 115 may determine one or more patterns 240 that overlap (e.g., include) the resources 245-a corresponding to the DCI message and the resources 245-b corresponding to the second DCI message. For example, the UE 115 may determine that the pattern 240-a overlaps with the resources 245-a (and the resources 245-b). In response, the UE 115 may rate match around the pattern 240-a and may use resources from the remaining patterns 240 (e.g., the pattern 240-b, the pattern 240-c, and the pattern 240-d) for the data channel message 220. Accordingly, the DCI message (or a location of the resources 245-a within the CORESET 235-a) may indicate that the UE 115 is to rate match around a detected pattern 240 (or sub-CORESET) that includes a detected PDCCH transmission corresponding to the DCI message, which may allow additional DCI messages (e.g., the second DCI message in resources 245-b directed to the second UE) to be rate matched around while still utilizing other resources of the CORESET 235-a for the data channel message 220.

FIG. 3C shows an example of a CORESET rate matching diagram 302 that supports rate matching around control resources in accordance with one or more aspects of the present disclosure. Aspects of the CORESET rate matching diagram 302 may implement or be implemented by one or more aspects as described herein with reference to FIGS. 1 and 2. For example, a UE 115 may perform a rate matching procedure to rate match a set of resources of a CORESET 235-b for a data channel message. The UE 115 may perform the rate matching procedure around resources 245-a corresponding to a first DCI message (e.g., the UE 115 may receive the DCI via the resources 245-a) and around resources 245-b corresponding to a second DCI message. The first DCI message may be for the UE 115 and the second DCI message may be for a second UE 115.

The UE 115 may subdivide the CORESET 235-b into two patterns 240 according to a second segmentation scheme (e.g., as indicated by the DCI message). In some cases, the second segmentation scheme may be based on a location of the resources 245-a (and the resources 245-b) within the CORESET 235-b as described herein with reference to FIG. 2. Then, the UE 115 may determine one or more patterns 240 that overlap (e.g., include) the resources 245-a corresponding to the DCI message and the resources 245-b corresponding to the second DCI message. For example, the UE 115 may determine that the pattern 240-e overlaps with the resources 245-a. In response, the UE 115 may rate match around the pattern 240-e and use resources from the remaining patterns 240 (e.g., the pattern 240-f) for the data channel message 220. Accordingly, the DCI message (or a location of the resources 245-a within the CORESET 235-b) may indicate that the UE 115 is to rate match around a detected pattern 240 (or sub-CORESET) that includes a detected PDCCH transmission corresponding to the DCI message. The second segmentation scheme may allow additional DCI messages (e.g., the second DCI message in resources 245-b directed to the second UE) to be rate matched around while still utilizing other resources of the CORESET 235-b for the data channel message 220.

FIG. 3D shows an example of a CORESET rate matching diagram 303 that supports rate matching around control resources in accordance with one or more aspects of the present disclosure. Aspects of the CORESET rate matching diagram 303 may implement or be implemented by one or more aspects as described herein with reference to FIGS. 1 and 2. For example, a UE 115 may perform a rate matching procedure to rate match a set of resources of a CORESET 235-c for a data channel message. The UE 115 may perform the rate matching procedure around resources 245-c corresponding to a first DCI message (e.g., the UE 115 may receive the DCI via the resources 245-c). The first DCI message may be for the UE 115.

The UE 115 may subdivide the CORESET 235-c into four patterns 240 according to a third segmentation scheme (e.g., as indicated by the DCI message). In some cases, the third segmentation scheme may be based on a location of the resources 245-c within the CORESET 235-c as described herein with reference to FIG. 2. In some examples, the third segmentation scheme may be based on a PDCCH mapping scheme that is frequency-first (e.g., rather than a time-first mapping scheme). Accordingly, the UE 115 may subdivide the CORESET 235-c into a quantity of patterns 240 such that each pattern 240 spans a respective duration and a respective range of frequencies (e.g., a pattern 240-g, a pattern 240-h, a pattern 240-i, and a pattern 240-j, as shown in FIG. 3D). Then, the UE 115 may determine one or more patterns 240 that overlap (e.g., include) the resources 245-c corresponding to the DCI message. For example, the UE 115 may determine that the pattern 240-g overlaps with the resources 245-c. In response, the UE 115 may rate match around the pattern 240-g and use resources from the remaining patterns 240 (e.g., the pattern 240-h, the pattern 240-i, and the pattern 240-j) for the data channel message 220. Accordingly, the DCI message (or a location of the resources 245-c within the CORESET 235-c) may indicate that the UE 115 is to rate match around a detected pattern 240 (or sub-CORESET) that includes a detected PDCCH transmission corresponding to the DCI message.

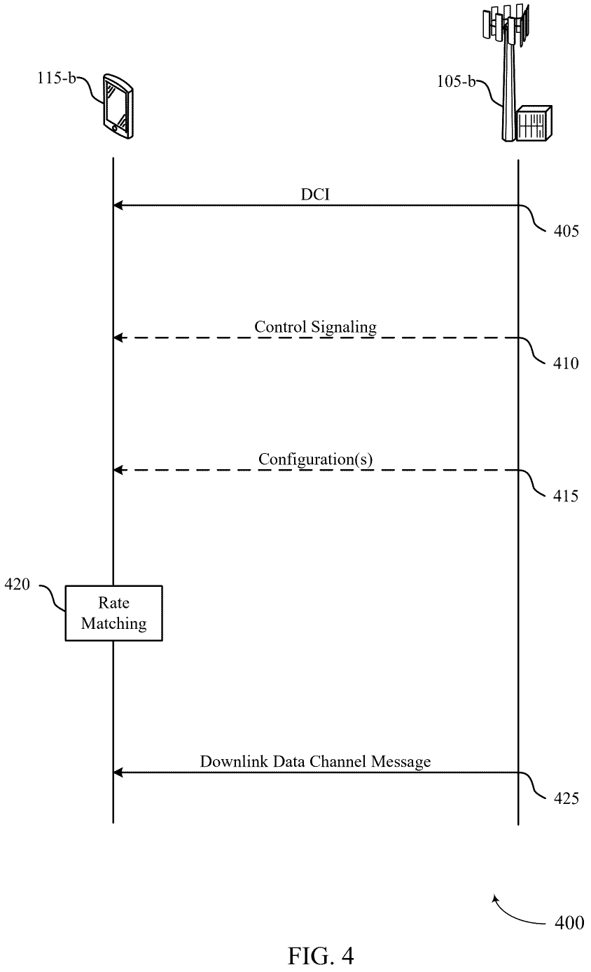

FIG. 4 shows an example of a process flow 400 that supports rate matching around control resources in accordance with one or more aspects of the present disclosure. The process flow 400 includes a UE 115-b and a network entity 105-b, which may be examples of the corresponding devices as described with respect to FIGS. 1, 2, and 3A-3D. In the following description of the process flow 400, the operations between the UE 115-b and the network entity 105-b may be performed in a different order than the example order shown. Some operations may also be omitted from the process flow 400, and other operations may be added to the process flow 400. Further, although some operations or signaling may be shown to occur at different times for discussion purposes, these operations may actually occur at the same time. In the process flow 400, if the UE 115-b is described to receive a particular message, it is noted that the network entity 105-b may output the particular message (e.g., prior to the receiving). Similarly, if the UE 115-b is described to transmit a particular message, it is noted that the network entity 105-b may obtain the particular message (e.g., after the transmitting).

At 405, the UE 115-b may receive, from the network entity 105- b and via a first CORESET, DCI including a codepoint that indicates a segmentation scheme that subdivides one or more CORESETs into respective sets of patterns. The one or more CORESETs may include the first CORESET. In some cases, the respective sets of patterns may be contiguous within each CORESET of the one or more CORESETs. Additionally, or alternatively, the respective set of patterns may be non-contiguous within each CORESET of the one or more CORESETs.

In some implementations, a configuration for the segmentation scheme may subdivide the one or more CORESETs into the respective sets of patterns according to a bitmap. In some cases, the configuration for the segmentation scheme may subdivide the one or more CORESETs into the respective sets of patterns according to an indication of a set of ranges (e.g., a starting frequency and an ending frequency, or a starting time and an ending time, or both) within the first CORESET. In some examples, the UE 115-b may receive an indication of a subset of patterns (e.g., corresponding to one or more CORESETs). The indication of the subset of patterns may be based on an explicit field of the DCI or a mask of a CRC field.

At 410, the UE 115-b may receive control signaling that indicates a second CORESET of the one or more CORESETs. In some cases, the DCI (e.g., received at 405) may include the control signaling that indicates the second CORESET. In some examples, the control signaling may be or may include a second DCI. The segmentation scheme may subdivide the second CORESET into a respective set of patterns.

At 415, the UE 115-b may receive one or more configurations. For example, the UE 115-b may receive a configuration via RRC signaling or via a MAC-CE. The configuration may be for one or more codepoints associated with the segmentation scheme, the rate matching procedure, or both (e.g., as described herein with reference to FIG. 2). In some cases, the UE 115-b may receive, via RRC signaling or via a MAC-CE, one or more respective configurations for performing a rate matching procedure. For example, the UE 115-b may receive a respective configuration for each search space of a set of search spaces, for each search space set group of a set of search space set groups, for each control resource set of a set of control resources sets, for each bandwidth part of a set of bandwidth parts, for each cell of a set of cells, or any combination thereof. Each respective configuration of the one or more respective configurations may be for one or more codepoints associated with a respective segmentation scheme, the rate matching procedure, or both.

At 420, the UE 115-b may perform the rate matching procedure based on the segmentation scheme and a set of resources corresponding to the DCI (e.g., used to receive the DCI). The UE 115-b may perform the rate matching procedure around a subset of the respective sets of patterns of at least one of the one or more CORESETs that overlaps with the set of resources. In some cases, the respective sets of patterns may be configured based on a PDSCH mapping type corresponding to the DCI (e.g., received at 405).

In some implementations, the UE 115-b may perform the rate matching procedure around the subset of the respective set of patterns of the second CORESET that overlap with the set of resources. In some examples, the UE 115-b may perform the rate matching procedure around the first CORESET based on the control signaling indicating the second CORESET. For example, if the control signaling indicates any portion of the second CORESET, the UE 115-b may perform the rate matching procedure around the entire first CORESET. In some cases, if the control signaling indicates the second CORESET, the UE 115-b may perform the rate matching procedure around a first subset of a first set of patterns corresponding to the first CORESET that overlap with the set of resources.

At 425, the UE 115-b may receive, form the network entity 105-b, the downlink data channel message. The UE 115-b may determine resources for the downlink data channel message based on the rate matching procedure (e.g., performed at 420).

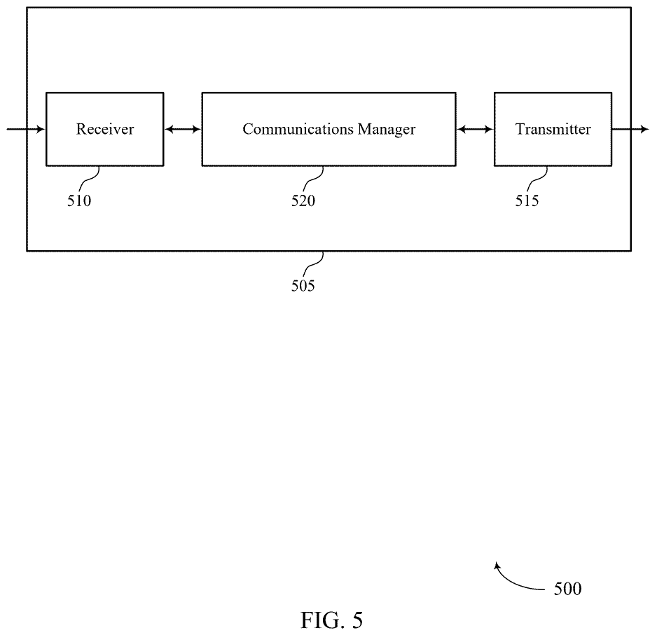

FIG. 5 shows a block diagram 500 of a device 505 that supports rate matching around control resources in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to rate matching around control resources). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to rate matching around control resources). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of rate matching around control resources as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, via a first CORESET, DCI including a codepoint that indicates a segmentation scheme that subdivides one or more CORESETs into respective pluralities of patterns, the one or more CORESETs including the first CORESET. The communications manager 520 is capable of, configured to, or operable to support a means for performing, based on the segmentation scheme and a set of resources corresponding to the DCI, a rate matching procedure around a subset of the respective set of multiple patterns of at least one of the one or more CORESETs that overlaps with the set of resources.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for rate matching around control resources, which may result in reduced processing, reduced power consumption, more efficient rate matching within a device, and more efficient utilization of communication resources (including CORESETs), among other advantages.

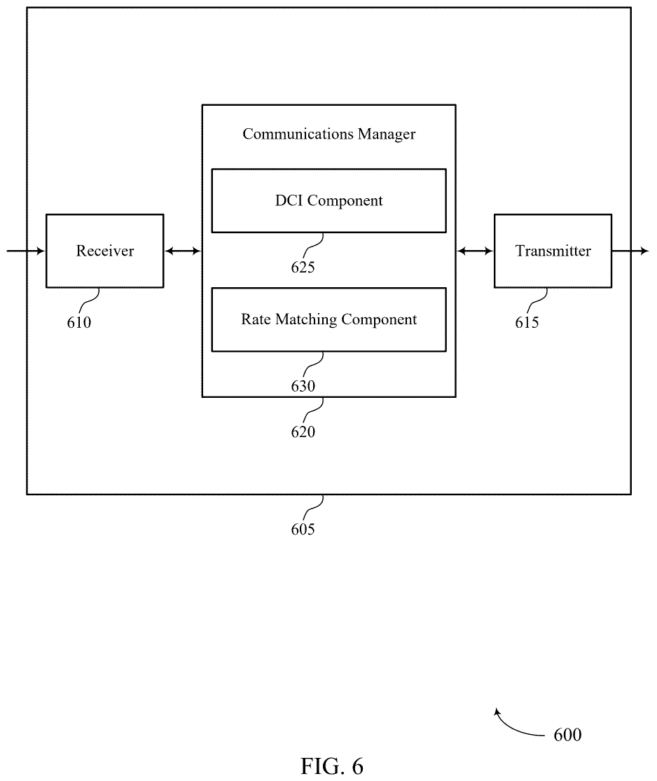

FIG. 6 shows a block diagram 600 of a device 605 that supports rate matching around control resources in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to rate matching around control resources). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to rate matching around control resources). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of rate matching around control resources as described herein. For example, the communications manager 620 may include a DCI component 625 a rate matching component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The DCI component 625 is capable of, configured to, or operable to support a means for receiving, via a first CORESET, DCI including a codepoint that indicates a segmentation scheme that subdivides one or more CORESETs into respective pluralities of patterns, the one or more CORESETs including the first CORESET. The rate matching component 630 is capable of, configured to, or operable to support a means for performing, based on the segmentation scheme and a set of resources corresponding to the DCI, a rate matching procedure around a subset of the respective set of multiple patterns of at least one of the one or more CORESETs that overlaps with the set of resources.

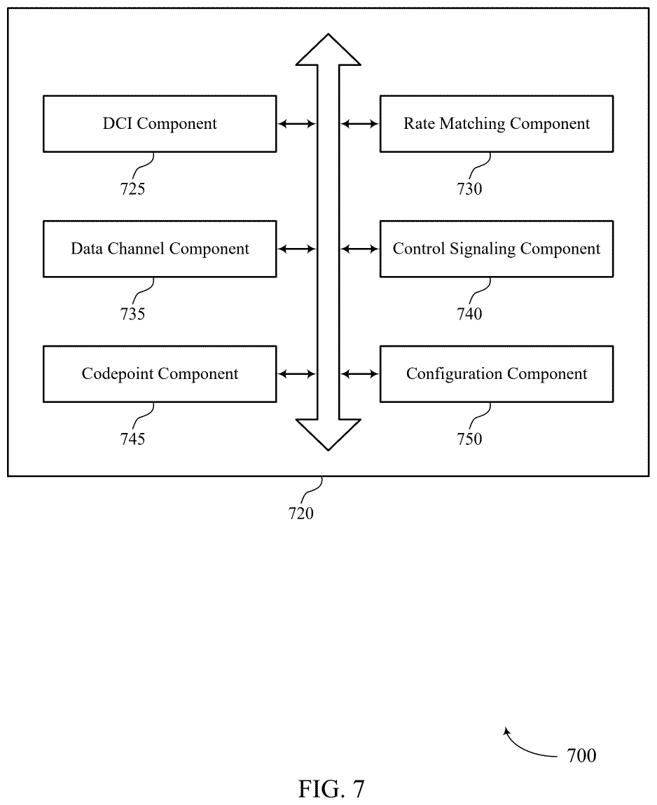

FIG. 7 shows a block diagram 700 of a communications manager 720 that supports rate matching around control resources in accordance with one or more aspects of the present disclosure. The communications manager 720 may be an example of aspects of a communications manager 520, a communications manager 620, or both, as described herein. The communications manager 720, or various components thereof, may be an example of means for performing various aspects of rate matching around control resources as described herein. For example, the communications manager 720 may include a DCI component 725, a rate matching component 730, a data channel component 735, a control signaling component 740, a codepoint component 745, a configuration component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The DCI component 725 is capable of, configured to, or operable to support a means for receiving, via a first CORESET, DCI including a codepoint that indicates a segmentation scheme that subdivides one or more CORESETs into respective pluralities of patterns, the one or more CORESETs including the first CORESET. The rate matching component 730 is capable of, configured to, or operable to support a means for performing, based on the segmentation scheme and a set of resources corresponding to the DCI, a rate matching procedure around a subset of the respective set of multiple patterns of at least one of the one or more CORESETs that overlaps with the set of resources.

In some examples, the DCI allocates resources for a downlink data channel message, and the data channel component 735 is capable of, configured to, or operable to support a means for receiving the downlink data channel message, where the resources for the downlink data channel message are determined based on the rate matching procedure.

In some examples, the control signaling component 740 is capable of, configured to, or operable to support a means for receiving control signaling that indicates a second CORESET of the one or more CORESETs, where the rate matching procedure is performed around the subset of the respective set of multiple patterns of the second CORESET that overlap with the set of resources.

In some examples, to support performing the rate matching procedure, the rate matching component 730 is capable of, configured to, or operable to support a means for performing the rate matching procedure around the first CORESET based on the control signaling indicating the second CORESET.

In some examples, to support performing the rate matching procedure, the rate matching component 730 is capable of, configured to, or operable to support a means for performing, based on the control signaling indicating the second CORESET, the rate matching procedure around a first subset of a first set of multiple patterns corresponding to the first CORESET that overlap with the set of resources.

In some examples, the segmentation scheme subdivides the second CORESET into a respective set of multiple patterns.

In some examples, the codepoint component 745 is capable of, configured to, or operable to support a means for receiving, via radio resource control signaling or via a medium access control-control element, a configuration for respective segmentation schemes associated with one or more codepoints including the codepoint, the rate matching procedure, or both.

In some examples, the configuration component 750 is capable of, configured to, or operable to support a means for receiving, via radio resource control signaling or via a medium access control-control element, a respective configuration for each search space of a set of search spaces, for each search space set group of a set of search space set groups, for each CORESET of a set of control resources sets, for each bandwidth part of a set of bandwidth parts, for each cell of a set of cells, or any combination thereof, where each respective configuration is for one or more codepoints associated with a respective segmentation scheme, the rate matching procedure, or both.

In some examples, the respective pluralities of patterns are contiguous within each CORESET of the one or more CORESETs.

In some examples, the respective pluralities of patterns are non-contiguous within each CORESET of the one or more CORESETs.

In some examples, a configuration for the segmentation scheme subdivides the one or more CORESETs into the respective pluralities of patterns according to a bitmap or according to an indication of a set of ranges within the first CORESET.

In some examples, an indication of the subset of the respective pluralities of patterns is based on an explicit field of the DCI or a mask of a cyclic redundancy check field.

In some examples, the respective pluralities of patterns are configured based on a physical downlink shared channel mapping type corresponding to the DCI.

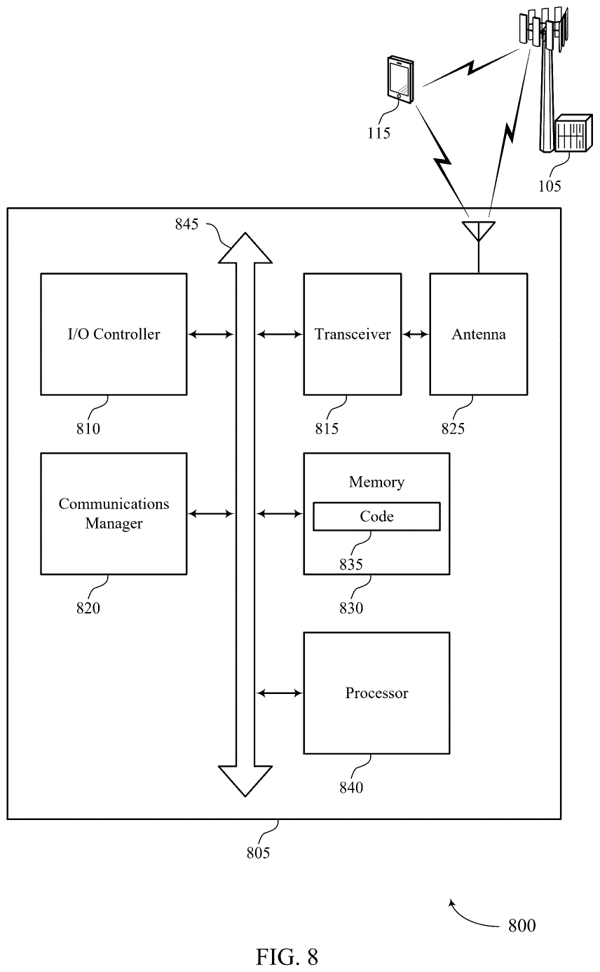

FIG. 8 shows a diagram of a system 800 including a device 805 that supports rate matching around control resources in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting rate matching around control resources). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, via a first CORESET, DCI including a codepoint that indicates a segmentation scheme that subdivides one or more CORESETs into respective pluralities of patterns, the one or more CORESETs including the first CORESET. The communications manager 820 is capable of, configured to, or operable to support a means for performing, based on the segmentation scheme and a set of resources corresponding to the DCI, a rate matching procedure around a subset of the respective set of multiple patterns of at least one of the one or more CORESETs that overlaps with the set of resources.

By including or configuring the communications manager 820 in accordance with examples as described herein, the device 805 may support techniques for rate matching around control resources, which may result in improved communication reliability, improved user experience related to reduced processing, reduced power consumption, more efficient rate matching within a device, improved utilization of processing capability, and more efficient utilization of communication resources (including CORESETs), among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of rate matching around control resources as described herein, or the at least one processor 840 and the at least one memory 830 may be otherwise configured to, individually or collectively, perform or support such operations.

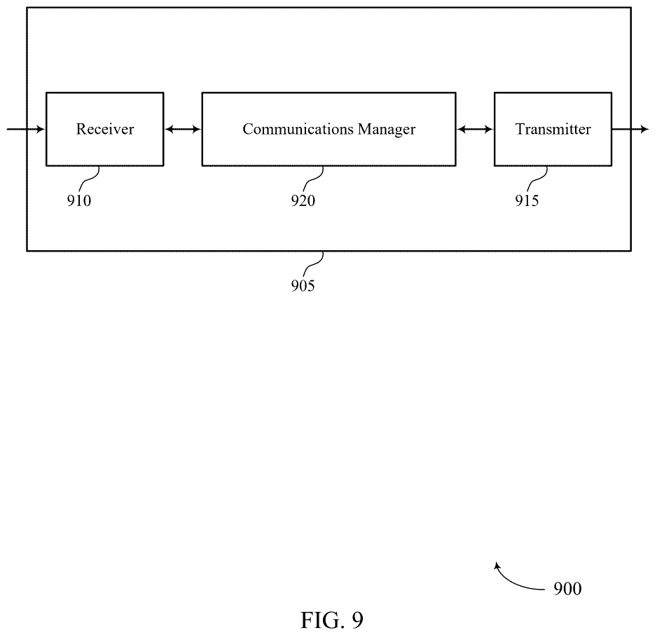

FIG. 9 shows a block diagram 900 of a device 905 that supports rate matching around control resources in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of rate matching around control resources as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, via a first CORESET, DCI including a codepoint that indicates a segmentation scheme that subdivides one or more CORESETs into respective pluralities of patterns, the one or more CORESETs including the first CORESET. The communications manager 920 is capable of, configured to, or operable to support a means for outputting a downlink data channel message, where, based on the segmentation scheme, resources for the downlink data channel message are rate matched around a subset of the respective set of multiple patterns of at least one of the one or more CORESETs that overlap with a set of resources corresponding to the dci.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for rate matching around control resources, which may result in reduced processing, reduced power consumption, more efficient rate matching within a device, and more efficient utilization of communication resources (including CORESETs), among other advantages.

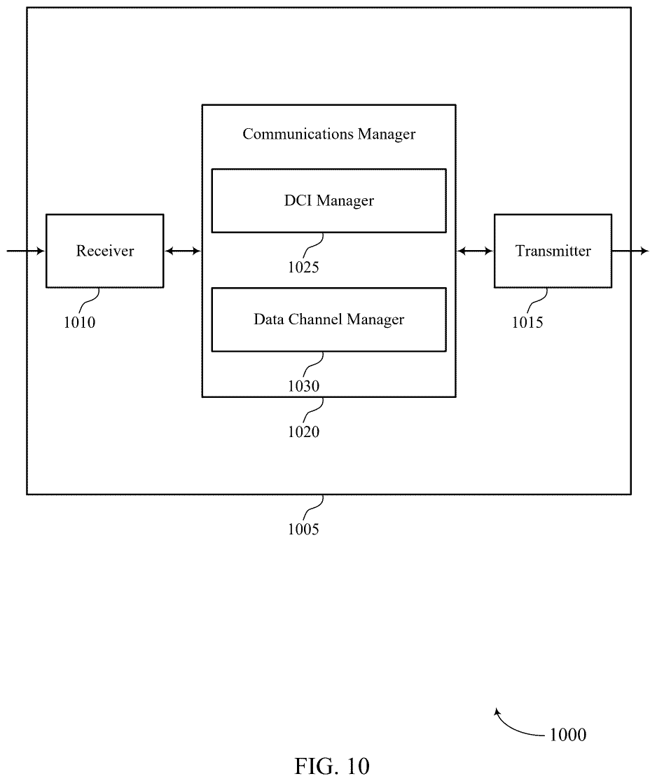

FIG. 10 shows a block diagram 1000 of a device 1005 that supports rate matching around control resources in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of rate matching around control resources as described herein. For example, the communications manager 1020 may include a DCI manager 1025 a data channel manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The DCI manager 1025 is capable of, configured to, or operable to support a means for outputting, via a first CORESET, DCI including a codepoint that indicates a segmentation scheme that subdivides one or more CORESETs into respective pluralities of patterns, the one or more CORESETs including the first CORESET. The data channel manager 1030 is capable of, configured to, or operable to support a means for outputting a downlink data channel message, where, based on the segmentation scheme, resources for the downlink data channel message are rate matched around a subset of the respective set of multiple patterns of at least one of the one or more CORESETs that overlap with a set of resources corresponding to the DCI.

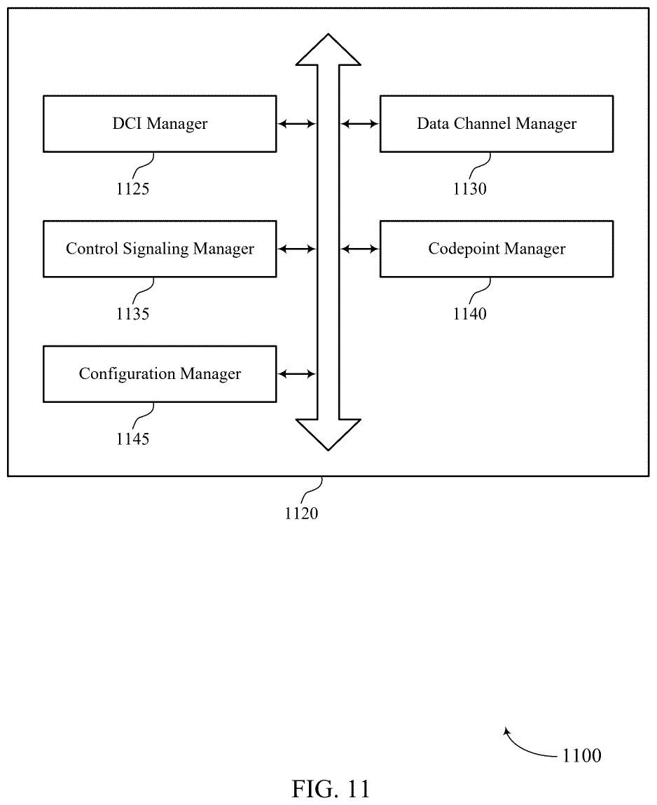

FIG. 11 shows a block diagram 1100 of a communications manager 1120 that supports rate matching around control resources in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of rate matching around control resources as described herein. For example, the communications manager 1120 may include a DCI manager 1125, a data channel manager 1130, a control signaling manager 1135, a codepoint manager 1140, a configuration manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The DCI manager 1125 is capable of, configured to, or operable to support a means for outputting, via a first CORESET, DCI including a codepoint that indicates a segmentation scheme that subdivides one or more CORESETs into respective pluralities of patterns, the one or more CORESETs including the first CORESET. The data channel manager 1130 is capable of, configured to, or operable to support a means for outputting a downlink data channel message, where, based on the segmentation scheme, resources for the downlink data channel message are rate matched around a subset of the respective set of multiple patterns of at least one of the one or more CORESETs that overlap with a set of resources corresponding to the DCI.

In some examples, the resources for the downlink data channel message are determined based on a rate matching procedure for the resources.

In some examples, the control signaling manager 1135 is capable of, configured to, or operable to support a means for outputting control signaling that indicates a second CORESET of the one or more CORESETs, where the resources for the downlink data channel message are rate matched around the subset of the respective set of multiple patterns of the second CORESET that overlap with the set of resources.

In some examples, the resources for the downlink data channel message are rate matched around the first CORESET based on the control signaling indicating the second CORESET.

In some examples, based on the control signaling indicating the second CORESET, the resources for the downlink data channel message are rate matched around a first subset of a first set of multiple patterns corresponding to the first CORESET that overlap with the set of resources.

In some examples, the segmentation scheme subdivides the second CORESET into a respective set of multiple patterns.

In some examples, the codepoint manager 1140 is capable of, configured to, or operable to support a means for outputting, via radio resource control signaling or via a medium access control-control element, a configuration for respective segmentation schemes associated with one or more codepoints including the codepoint, a rate matching procedure for the resources, or both.

In some examples, the configuration manager 1145 is capable of, configured to, or operable to support a means for outputting, via radio resource control signaling or via a medium access control-control element, a respective configuration for each search space of a set of search spaces, for each search space set group of a set of search space set groups, for each CORESET of a set of control resources sets, for each bandwidth part of a set of bandwidth parts, for each cell of a set of cells, or any combination thereof, where each respective configuration is for one or more codepoints associated with a respective segmentation scheme, a rate matching procedure for the resources, or both.

In some examples, the respective pluralities of patterns are contiguous within each CORESET of the one or more CORESETs.

In some examples, the respective pluralities of patterns are non-contiguous within each CORESET of the one or more CORESETs.

In some examples, a configuration for the segmentation scheme subdivides the one or more CORESETs into the respective pluralities of patterns according to a bitmap or according to an indication of a set of ranges within the first CORESET.

In some examples, an indication of the subset of the respective pluralities of patterns is based on an explicit field of the DCI or a mask of a cyclic redundancy check field.

In some examples, the respective pluralities of patterns are configured based on a physical downlink shared channel mapping type corresponding to the DCI.

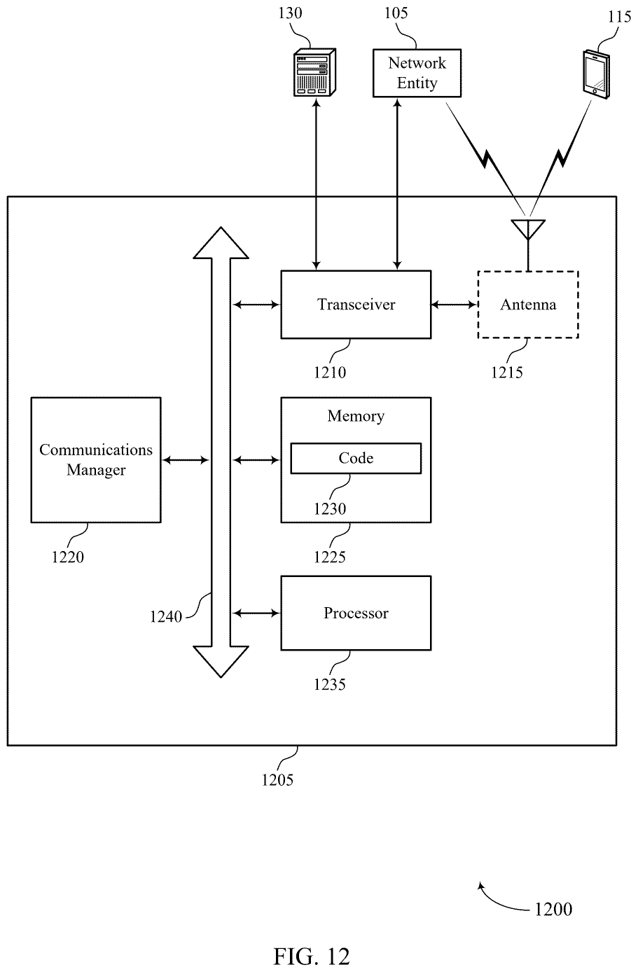

FIG. 12 shows a diagram of a system 1200 including a device 1205 that supports rate matching around control resources in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting rate matching around control resources). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, via a first CORESET, DCI including a codepoint that indicates a segmentation scheme that subdivides one or more CORESETs into respective pluralities of patterns, the one or more CORESETs including the first CORESET. The communications manager 1220 is capable of, configured to, or operable to support a means for outputting a downlink data channel message, where, based on the segmentation scheme, resources for the downlink data channel message are rate matched around a subset of the respective set of multiple patterns of at least one of the one or more CORESETs that overlap with a set of resources corresponding to the DCI.

By including or configuring the communications manager 1220 in accordance with examples as described herein, the device 1205 may support techniques for rate matching around control resources, which may result in improved communication reliability, improved user experience related to reduced processing, reduced power consumption, more efficient rate matching within a device, improved utilization of processing capability, and more efficient utilization of communication resources (including CORESETs), among other advantages.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of rate matching around control resources as described herein, or the at least one processor 1235 and the at least one memory 1225 may be otherwise configured to, individually or collectively, perform or support such operations.

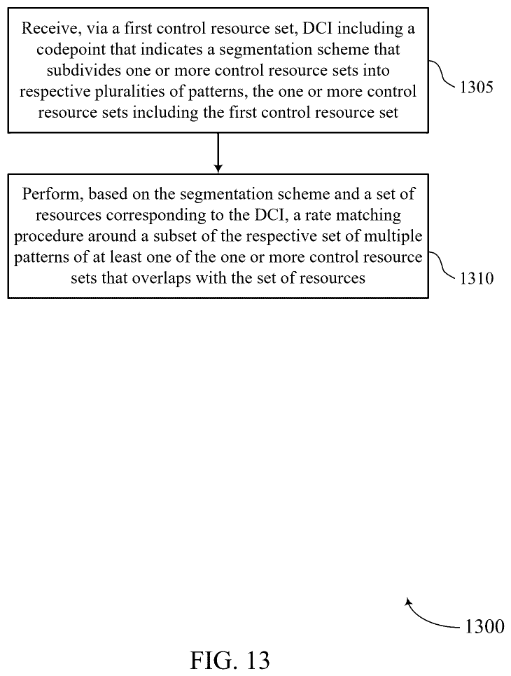

FIG. 13 shows a flowchart illustrating a method 1300 that supports rate matching around control resources in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, via a first CORESET, DCI including a codepoint that indicates a segmentation scheme that subdivides one or more CORESETs into respective pluralities of patterns, the one or more CORESETs including the first CORESET. The operations of 1305 may be performed in accordance with examples as disclosed herein. In some examples, aspects of the operations of 1305 may be performed by a DCI component 725 as described with reference to FIG. 7.

At 1310, the method may include performing, based on the segmentation scheme and a set of resources corresponding to the DCI, a rate matching procedure around a subset of the respective set of multiple patterns of at least one of the one or more CORESETs that overlaps with the set of resources. The operations of 1310 may be performed in accordance with examples as disclosed herein. In some examples, aspects of the operations of 1310 may be performed by a rate matching component 730 as described with reference to FIG. 7.

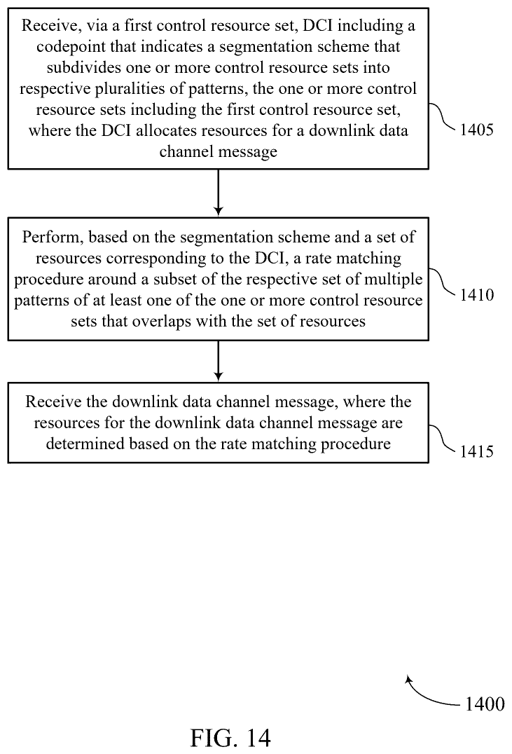

FIG. 14 shows a flowchart illustrating a method 1400 that supports rate matching around control resources in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, via a first CORESET, DCI including a codepoint that indicates a segmentation scheme that subdivides one or more CORESETs into respective pluralities of patterns, the one or more CORESETs including the first CORESET, where the DCI allocates resources for a downlink data channel message. The operations of 1405 may be performed in accordance with examples as disclosed herein. In some examples, aspects of the operations of 1405 may be performed by a DCI component 725 as described with reference to FIG. 7.

At 1410, the method may include performing, based on the segmentation scheme and a set of resources corresponding to the DCI, a rate matching procedure around a subset of the respective set of multiple patterns of at least one of the one or more CORESETs that overlaps with the set of resources. The operations of 1410 may be performed in accordance with examples as disclosed herein. In some examples, aspects of the operations of 1410 may be performed by a rate matching component 730 as described with reference to FIG. 7.

At 1415, the method may include receiving the downlink data channel message, where the resources for the downlink data channel message are determined based on the rate matching procedure. The operations of 1415 may be performed in accordance with examples as disclosed herein. In some examples, aspects of the operations of 1415 may be performed by a data channel component 735 as described with reference to FIG. 7.

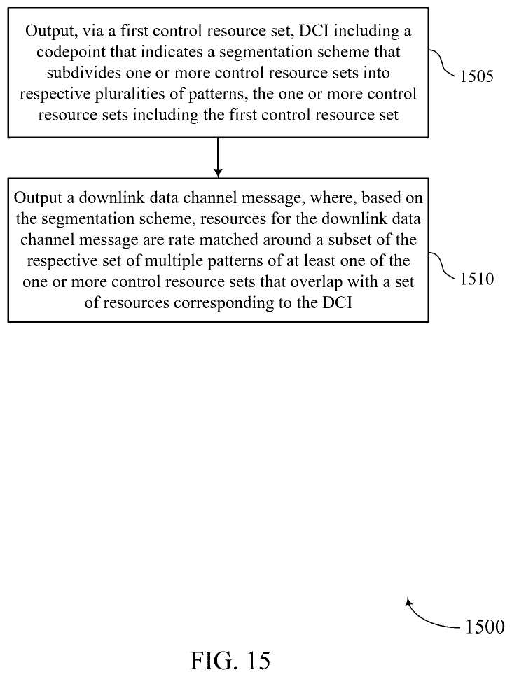

FIG. 15 shows a flowchart illustrating a method 1500 that supports rate matching around control resources in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting, via a first CORESET, DCI including a codepoint that indicates a segmentation scheme that subdivides one or more CORESETs into respective pluralities of patterns, the one or more CORESETs including the first CORESET. The operations of 1505 may be performed in accordance with examples as disclosed herein. In some examples, aspects of the operations of 1505 may be performed by a DCI manager 1125 as described with reference to FIG. 11.

At 1510, the method may include outputting a downlink data channel message, where, based on the segmentation scheme, resources for the downlink data channel message are rate matched around a subset of the respective set of multiple patterns of at least one of the one or more CORESETs that overlap with a set of resources corresponding to the DCI. The operations of 1510 may be performed in accordance with examples as disclosed herein. In some examples, aspects of the operations of 1510 may be performed by a data channel manager 1130 as described with reference to FIG. 11.

The following provides an overview of aspects of the present disclosure:
Aspect 1: A method for wireless communications at a UE, comprising: receiving, via a first CORESET, DCI that indicates a segmentation scheme comprising a codepoint that subdivides one or more CORESETs into respective pluralities of patterns, the one or more CORESETs comprising the first CORESET; and performing, based at least in part on the segmentation scheme and a set of resources corresponding to the DCI, a rate matching procedure around a subset of the respective plurality of patterns of at least one of the one or more CORESETs that overlaps with the set of resources.
Aspect 2: The method of aspect 1, wherein the DCI allocates resources for a downlink data channel message, the method further comprising: receiving the downlink data channel message, wherein the resources for the downlink data channel message are determined based at least in part on the rate matching procedure.
Aspect 3: The method of any of aspects 1 through 2, further comprising: receiving control signaling that indicates a second CORESET of the one or more CORESETs, wherein the rate matching procedure is performed around the subset of the respective plurality of patterns of the second CORESET that overlap with the set of resources.
Aspect 4: The method of aspect 3, wherein performing the rate matching procedure comprises: performing the rate matching procedure around the first CORESET based at least in part on the control signaling indicating the second CORESET.
Aspect 5: The method of any of aspects 3 through 4, wherein performing the rate matching procedure comprises: performing, based at least in part on the control signaling indicating the second CORESET, the rate matching procedure around a first subset of a first plurality of patterns corresponding to the first CORESET that overlap with the set of resources.
Aspect 6: The method of any of aspects 3 through 5, wherein the segmentation scheme subdivides the second CORESET into a respective plurality of patterns.
Aspect 7: The method of any of aspects 1 through 6, further comprising: receiving, via RRC signaling or via a MAC-CE, a configuration for respective segmentation schemes associated with one or more codepoints including the codepoint, the rate matching procedure, or both.
Aspect 8: The method of any of aspects 1 through 7, further comprising: receiving, via RRC signaling or via a MAC-CE, a respective configuration for each search space of a set of search spaces, for each search space set group of a set of search space set groups, for each CORESET of a set of control resources sets, for each bandwidth part of a set of bandwidth parts, for each cell of a set of cells, or any combination thereof, wherein each respective configuration is for one or more codepoints associated with a respective segmentation scheme, the rate matching procedure, or both.
Aspect 9: The method of any of aspects 1 through 8, wherein the respective pluralities of patterns are contiguous within each CORESET of the one or more CORESETs.
Aspect 10: The method of any of aspects 1 through 9, wherein the respective pluralities of patterns are non-contiguous within each CORESET of the one or more CORESETs.
Aspect 11: The method of any of aspects 1 through 10, wherein a configuration for the segmentation scheme subdivides the one or more CORESETs into the respective pluralities of patterns according to a bitmap or according to an indication of a set of ranges within the first CORESET.
Aspect 12: The method of any of aspects 1 through 11, wherein an indication of the subset of the respective pluralities of patterns is based at least in part on an explicit field of the DCI or a mask of a cyclic redundancy check field.
Aspect 13: The method of any of aspects 1 through 12, wherein the respective pluralities of patterns are configured based at least in part on a PDSCH mapping type corresponding to the DCI.
Aspect 14: A method for wireless communications at a network entity, comprising: outputting, via a first CORESET, DCI comprising a codepoint that indicates a segmentation scheme that subdivides one or more CORESETs into respective pluralities of patterns, the one or more CORESETs comprising the first CORESET; and outputting a downlink data channel message, wherein, based at least in part on the segmentation scheme, resources for the downlink data channel message are rate matched around a subset of the respective plurality of patterns of at least one of the one or more CORESETs that overlap with a set of resources corresponding to the DCI.
Aspect 15: The method of aspect 14, wherein the resources for the downlink data channel message are determined based at least in part on a rate matching procedure for the resources.
Aspect 16: The method of any of aspects 14 through 15, further comprising: outputting control signaling that indicates a second CORESET of the one or more CORESETs, wherein the resources for the downlink data channel message are rate matched around the subset of the respective plurality of patterns of the second CORESET that overlap with the set of resources.
Aspect 17: The method of aspect 16, wherein the resources for the downlink data channel message are rate matched around the first CORESET based at least in part on the control signaling indicating the second CORESET.
Aspect 18: The method of any of aspects 16 through 17, wherein based at least in part on the control signaling indicating the second CORESET, the resources for the downlink data channel message are rate matched around a first subset of a first plurality of patterns corresponding to the first CORESET that overlap with the set of resources.
Aspect 19: The method of any of aspects 16 through 18, wherein the segmentation scheme subdivides the second CORESET into a respective plurality of patterns.
Aspect 20: The method of any of aspects 14 through 19, further comprising: outputting, via RRC signaling or via a MAC-CE, a configuration for respective segmentation schemes associated with one or more codepoints including the codepoint, a rate matching procedure for the resources, or both.
Aspect 21: The method of any of aspects 14 through 20, further comprising: outputting, via RRC signaling or via a MAC-CE, a respective configuration for each search space of a set of search spaces, for each search space set group of a set of search space set groups, for each CORESET of a set of control resources sets, for each bandwidth part of a set of bandwidth parts, for each cell of a set of cells, or any combination thereof, wherein each respective configuration is for one or more codepoints associated with a respective segmentation scheme, a rate matching procedure for the resources, or both.
Aspect 22: The method of any of aspects 14 through 21, wherein the respective pluralities of patterns are contiguous within each CORESET of the one or more CORESETs.
Aspect 23: The method of any of aspects 14 through 22, wherein the respective pluralities of patterns are non-contiguous within each CORESET of the one or more CORESETs.
Aspect 24: The method of any of aspects 14 through 23, wherein a configuration for the segmentation scheme subdivides the one or more CORESETs into the respective pluralities of patterns according to a bitmap or according to an indication of a set of ranges within the first CORESET.
Aspect 25: The method of any of aspects 14 through 24, wherein an indication of the subset of the respective pluralities of patterns is based at least in part on an explicit field of the DCI or a mask of a cyclic redundancy check field.
Aspect 26: The method of any of aspects 14 through 25, wherein the respective pluralities of patterns are configured based at least in part on a PDSCH mapping type corresponding to the DCI.
Aspect 27: A UE for wireless communications, comprising one or more memories storing processor-executable code, and one or more processors coupled with the one or more memories and individually or collectively operable to execute the code to cause the UE to perform a method of any of aspects 1 through 13.
Aspect 28: A UE for wireless communications, comprising at least one means for performing a method of any of aspects 1 through 13.
Aspect 29: A non-transitory computer-readable medium storing code for wireless communications, the code comprising instructions executable by one or more processors to perform a method of any of aspects 1 through 13.
Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.
Aspect 31: A network entity for wireless communications, comprising at least one means for performing a method of any of aspects 14 through 26.
Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a first control resource set, downlink control information comprising a codepoint that indicates a segmentation scheme that subdivides one or more control resource sets into respective pluralities of patterns, the one or more control resource sets comprising the first control resource set; and
perform, based at least in part on the segmentation scheme and a set of resources corresponding to the downlink control information, a rate matching procedure around a subset of the respective plurality of patterns of at least one of the one or more control resource sets that overlaps with the set of resources.

2. The UE of claim 1, wherein the downlink control information allocates resources for a downlink data channel message, and the one or more processors are individually or collectively further operable to execute the code to cause the UE to:
receive the downlink data channel message, wherein the resources for the downlink data channel message are determined based at least in part on the rate matching procedure.

3. The UE of claim 1, wherein the one or more processors are individually or collectively further operable to execute the code to cause the UE to:
receive control signaling that indicates a second control resource set of the one or more control resource sets, wherein the rate matching procedure is performed around the subset of the respective plurality of patterns of the second control resource set that overlap with the set of resources.

4. The UE of claim 3, wherein, to perform the rate matching procedure, the one or more processors are individually or collectively operable to execute the code to cause the UE to:
perform the rate matching procedure around the first control resource set based at least in part on the control signaling indicating the second control resource set.

5. The UE of claim 3, wherein, to perform the rate matching procedure, the one or more processors are individually or collectively operable to execute the code to cause the UE to:
perform, based at least in part on the control signaling indicating the second control resource set, the rate matching procedure around a first subset of a first plurality of patterns corresponding to the first control resource set that overlap with the set of resources.

6. The UE of claim 3, wherein the segmentation scheme subdivides the second control resource set into a respective plurality of patterns.

7. The UE of claim 1, wherein the one or more processors are individually or collectively further operable to execute the code to cause the UE to:
receive, via radio resource control signaling or via a medium access control-control element, a configuration for respective segmentation schemes associated with one or more codepoints including the codepoint, the rate matching procedure, or both.

8. The UE of claim 1, wherein the one or more processors are individually or collectively further operable to execute the code to cause the UE to:
receive, via radio resource control signaling or via a medium access control-control element, a respective configuration for each search space of a set of search spaces, for each search space set group of a set of search space set groups, for each control resource set of a set of control resources sets, for each bandwidth part of a set of bandwidth parts, for each cell of a set of cells, or any combination thereof, wherein each respective configuration is for one or more codepoints associated with a respective segmentation scheme, the rate matching procedure, or both.

9. The UE of claim 1, wherein the respective pluralities of patterns are contiguous within each control resource set of the one or more control resource sets.

10. The UE of claim 1, wherein the respective pluralities of patterns are non-contiguous within each control resource set of the one or more control resource sets.

11. The UE of claim 1, wherein a configuration for the segmentation scheme subdivides the one or more control resource sets into the respective pluralities of patterns according to a bitmap or according to an indication of a set of ranges within the first control resource set.

12. The UE of claim 1, wherein an indication of the subset of the respective pluralities of patterns is based at least in part on an explicit field of the downlink control information or a mask of a cyclic redundancy check field.

13. The UE of claim 1, wherein the respective pluralities of patterns are configured based at least in part on a physical downlink shared channel mapping type corresponding to the downlink control information.

14. A network entity, comprising:
one or more memories storing processor-executable code; and
one or more processors coupled with the one or more memories and individually or collectively operable to execute the code to cause the network entity to:
output, via a first control resource set, downlink control information comprising a codepoint that indicates a segmentation scheme that subdivides one or more control resource sets into respective pluralities of patterns, the one or more control resource sets comprising the first control resource set; and
output a downlink data channel message, wherein, based at least in part on the segmentation scheme, resources for the downlink data channel message are rate matched around a subset of the respective plurality of patterns of at least one of the one or more control resource sets that overlap with a set of resources corresponding to the downlink control information.

15. The network entity of claim 14, wherein the resources for the downlink data channel message are determined based at least in part on a rate matching procedure for the resources.

16. The network entity of claim 14, wherein the one or more processors are individually or collectively further operable to execute the code to cause the network entity to:
output control signaling that indicates a second control resource set of the one or more control resource sets, wherein the resources for the downlink data channel message are rate matched around the subset of the respective plurality of patterns of the second control resource set that overlap with the set of resources.

17. The network entity of claim 16, wherein the resources for the downlink data channel message are rate matched around the first control resource set based at least in part on the control signaling indicating the second control resource set.

18. The network entity of claim 16, wherein based at least in part on the control signaling indicating the second control resource set, the resources for the downlink data channel message are rate matched around a first subset of a first plurality of patterns corresponding to the first control resource set that overlap with the set of resources.

19. The network entity of claim 16, wherein the segmentation scheme subdivides the second control resource set into a respective plurality of patterns.

20. The network entity of claim 14, wherein the one or more processors are individually or collectively further operable to execute the code to cause the network entity to:
output, via radio resource control signaling or via a medium access control-control element, a configuration for respective segmentation schemes associated with one or more codepoints including the codepoint, a rate matching procedure for the resources, or both.

21. The network entity of claim 14, wherein the one or more processors are individually or collectively further operable to execute the code to cause the network entity to:
output, via radio resource control signaling or via a medium access control-control element, a respective configuration for each search space of a set of search spaces, for each search space set group of a set of search space set groups, for each control resource set of a set of control resources sets, for each bandwidth part of a set of bandwidth parts, for each cell of a set of cells, or any combination thereof, wherein each respective configuration is for one or more codepoints associated with a respective segmentation scheme, a rate matching procedure for the resources, or both.

22. The network entity of claim 14, wherein the respective pluralities of patterns are contiguous within each control resource set of the one or more control resource sets.

23. The network entity of claim 14, wherein the respective pluralities of patterns are non-contiguous within each control resource set of the one or more control resource sets.

24. The network entity of claim 14, wherein a configuration for the segmentation scheme subdivides the one or more control resource sets into the respective pluralities of patterns according to a bitmap or according to an indication of a set of ranges within the first control resource set.

25. The network entity of claim 14, wherein an indication of the subset of the respective pluralities of patterns is based at least in part on an explicit field of the downlink control information or a mask of a cyclic redundancy check field.

26. The network entity of claim 14, wherein the respective pluralities of patterns are configured based at least in part on a physical downlink shared channel mapping type corresponding to the downlink control information.

27. A method for wireless communications at a user equipment (UE), comprising:
receiving, via a first control resource set, downlink control information that indicates a segmentation scheme that subdivides one or more control resource sets into respective pluralities of patterns, the one or more control resource sets comprising the first control resource set; and
performing, based at least in part on the segmentation scheme and a set of resources corresponding to the downlink control information, a rate matching procedure around a subset of the respective plurality of patterns of at least one of the one or more control resource sets that overlaps with the set of resources.

28. The method of claim 27, wherein the downlink control information allocates resources for a downlink data channel message, the method further comprising:
receiving the downlink data channel message, wherein the resources for the downlink data channel message are determined based at least in part on the rate matching procedure.

29. A method for wireless communications at a network entity, comprising:
outputting, via a first control resource set, downlink control information that indicates a segmentation scheme that subdivides one or more control resource sets into respective pluralities of patterns, the one or more control resource sets comprising the first control resource set; and
outputting a downlink data channel message, wherein, based at least in part on the segmentation scheme, resources for the downlink data channel message are rate matched around a subset of the respective plurality of patterns of at least one of the one or more control resource sets that overlap with a set of resources corresponding to the downlink control information.

30. The method of claim 29, wherein the resources for the downlink data channel message are determined based at least in part on a rate matching procedure for the resources.
